(19) United States
(12) Patent Application Publication
(10) Pub. No.: US 2019/0091758 A1
(43) Pub. Date: Mar. 28, 2019

(54) TWO-COMPONENT BINDER SYSTEM FOR THE POLYURETHANE COLD-BOX PROCESS

(71) Applicant: HÜTTENES-ALBERTUS CHEMISCHE WERKE GESELLSCHAFT MIT BESCHRÄNKTER HAFTUNG, Düsseldorf (DE)

(72) Inventors: Gérard LADÉGOURDIE, Düsseldorf (DE); Nicolas EGELER, Krefeld (DE); Jaime DÍAZ FERNÁNDEZ, Bilbao (Vizcaya) (ES)

(73) Assignee: HÜTTENES-ALBERTUS CHEMISCHE WERKE GESELLSCHAFT MIT BESCHRÄNKTER HAFTUNG, Düsseldorf (DE)

(21) Appl. No.: 16/082,348

(22) PCT Filed: Mar. 8, 2017
(86) PCT No.: PCT/EP2017/055446

§ 371 Date: Sep. 5, 2018

(30) Foreign Application Priority Data
Mar. 9, 2016 (DE) 10 2016 203 896.6

(51) Int. Cl. B22C 1/22; C08G 18/54; C08G 18/76

(52) U.S. Cl. CPC B22C 1/2273; C08G 18/7664; C08G 18/542

(57) ABSTRACT

A description is given of a two-component binder system for use in the polyurethane cold box process, a mixture for curing by contacting with a tertiary amine, a method for producing a feeder, a foundry mold or a foundry core, and also feeders, foundry molds and foundry cores producible by this method, and the use of a two-component binder system of the invention or of a mixture of the invention for binding a mold raw material or a mixture of mold raw materials in the polyurethane cold box process.

The present application relates to a two-component binder system for use in the polyurethane cold box process, a mixture for curing by contacting with a tertiary amine (the term “tertiary amine” in the context of this application also including mixtures of two or more tertiary amines), a method for producing a feeder, a foundry mold or a foundry core, and also feeders, foundry molds and foundry cores producible by this method, and the use of a two-component binder system of the invention or of a mixture of the invention for binding a mold raw material or a mixture of mold raw materials in the polyurethane cold box process.

In the production of feeders, foundry molds, and foundry cores, the mold raw material is often bound using two-component binder systems which are cold-curing with formation of polyurethane. These binder systems consist of two components: a polyol (normally in solution in a solvent) having at least two OH groups in the molecule (polyol component), and a polyisocyanate (in solution in a solvent or solvent-free) having at least two isocyanate groups in the molecule (polyisocyanate component). In the shaped molding mixture, the two components, added separately to a mold raw material in order to produce a molding mixture, react in a polyaddition reaction to form a cured polyurethane binder. This curing takes place in the presence of basic catalysts, preferably in the form of tertiary amines, which are introduced into the shaping mold with a carrier gas after the molding mixture has been shaped.

The polyol component is usually a phenolic resin in solution in a solvent, i.e., a condensation product of one or more (optionally substituted) phenols with one or more aldehydes (especially formaldehyde). The polyol component is therefore referred to below as phenolic resin component.

The polyisocyanate component used is a polyisocyanate having at least two isocyanate groups in the molecule, in undissolved form or in solution in a solvent. Aromatic polyisocyanates are preferred. In the case of a polyisocyanate component in the form of a solution, the concentration of the polyisocyanate is generally above 70%, based on the total mass of the polyisocyanate component.

For producing feeders, foundry cores, and foundry molds by the polyurethane cold box process (also termed “urethane cold box process”), a molding mixture is first of all prepared, by the mixing of a granular mold raw material with the two components of the above-described two-component binder system. The proportions of the two components of the two-component binder system are preferably made such as to result in an excess of the NCO groups relative to the number of OH groups. Two-component binder systems customary at present typically have an excess of NCO groups of up to 20%, based on the number of OH groups. In the case of foundry cores and foundry molds, the total amount of binder (including, where appropriate, the additives and solvents present in the binder components) is customarily in the range from about 1% to 2%, based on the mass of mold raw material employed, and, in the case of feeders, it is customarily in the range from about 5% to 18%, based on the other constituents of the feeder composition.

The molding mixture is then shaped. This is followed, with brief gassing with a tertiary amine (the term “tertiary amine” in the context of this application also including mixtures of two or more tertiary amines) as catalyst, by the curing of the shaped molding mixture. The amount of catalyst in the form of tertiary amine that is required is in the range from 0.035% to 0.11%, based in each case on the mass of mold raw material employed. Based on the mass of binder, the amount of catalyst in the form of tertiary amine required is typically 3% to 15%, depending on the nature of the tertiary amine used. Subsequently the feeder, the foundry core or the foundry mold can be taken from the shaping mold and used for the casting of metal, such as in engine casting, for example.

During the gassing itself, the feeders, foundry cores and/or foundry molds acquire a measurable strength (referred to as “initial strength” or “instantaneous strength”), which slowly increases, after the end of gassing, to the ultimate strength values. In practice, the desire is for very high initial strengths, to allow the feeders, foundry cores and/or foundry molds to be taken from the shaping mold as soon as possible after gassing, to leave the shaping mold available again for a new operation.

Two-component binder systems which are cold-curing with formation of polyurethane, as described above, are also used in the polyurethane no-bake process. In that process, curing takes place with exposure to a liquid catalyst in the form of a solution of a tertiary amine which is added to the molding mixture.

Two-component binder systems for use in the polyurethane cold box process are described, for example, in U.S. Pat. Nos. 3,409,579, 4,546,124, DE 10 2004 057 671, EP 0 771 599, EP 1 057 554 and DE 10 2010 051 567 and in patent application PCT/EP2015/070751, which is not a pre-priority publication. A two-component binder system for use in the polyurethane no-bake process is described, for example, in U.S. Pat. No. 5,101,001.

In the foundry industry there is a continual demand for further-developed two-component binder systems for use in the polyurethane cold box process, having improved processing properties, particularly in relation to the time during which the molding mixture mixed with the two binder components can be stored prior to its further processing to give foundry molds and/or foundry cores, in spite of the high reactivity of the binder system (“sand life time”), and the initial strength of feeders, foundry cores, and foundry molds, respectively.

This object is achieved by means of a two-component binder system for use in the polyurethane cold box process,

consisting of a phenolic resin component and of a separate polyisocyanate component, where

the phenolic resin component comprises an ortho-fused phenolic resole having etherified and/or methylol groups, and a solvent unetherified terminal and optionally one or more additives

and

the polyisocyanate component comprises a polyisocyanate having at least two isocyanate groups per molecule and also optionally a solvent, and optionally one or more additives,

the fraction of the mass of polyisocyanate in the polyisocyanate component being 90% or more, preferably 92% or more, more preferably 95% or more, very preferably 98% or more, based in each case on the total mass of the polyisocyanate component, and the stoichiometric ratio of isocyanate groups in the polyisocyanate component to hydroxyl groups in the phenolic resin component being less than 1.2, and preferably in the range from 0.5 to <1, more preferably in the range from 0.7 to 0.95,

and

the phenolic resin component being free from compounds from the group of the alkyl silicates and alkyl silicate oligomers,

and, based on the total mass of the phenolic resin component,
the fraction of aromatic hydrocarbons is less than 39.43%, preferably less than 38%,
and the fraction of rapeseed oil methyl ester is less than 39.43%, preferably less than 30%.

The term “hydrocarbons”, in accordance with its usual meaning within the field of chemistry, refers to organic compounds which consist only of carbon and hydrogen.

With preference, based on the total mass of the phenolic resin component of the two-component binder of the invention,
the fraction of aromatic hydrocarbons is 35% or less, more preferably 30% or less, very preferably 25% or less,

and/or
the fraction of rapeseed oil methyl ester is 28% or less, more preferably more 25% or less, very preferably 20% or less.

Surprisingly it has been found that binder systems of the invention exhibit a long sand life time, and at the same time permit a high initial strength of feeders, foundry cores, and/or foundry molds. Binder systems which by virtue of high reactivity permit a high initial strength of feeders, foundry cores, and foundry molds customarily have a relatively short sand life time, owing to their high reactivity, whereas binder systems with a relatively long sand life time have a lower reactivity which allows only a relatively low initial strength of feeders, foundry cores, and foundry molds.

In the two-component binder system of the invention, the stoichiometric ratio of isocyanic groups in the polyisocyanate component to hydroxyl groups in the phenol resin component is preferably in the range from 0.5 to 1.16, more preferably in the range from 0.55 to 1.1, more preferably still in the range from 0.6 to 0.99, very preferably in the range from 0.7 to 0.95, even more preferably in the range from 0.72 to 0.92, and especially preferably in the range from 0.75 to 0.9.

In the two-component binder system of the invention, the phenolic resin component and the polyisocyanate component are separate from one another, meaning that they are present in separate containers, since the above-described addition reaction (polyurethane formation) between the resole of the phenolic resin component and the polyisocyanate of the polyisocyanate component is to take place not until the two components have been mixed with a mold raw material or a mixture of two or more mold raw materials in a molding mixture and this molding mixture has been shaped.

The phenolic resin component of the two-component binder system of the invention comprises a phenolic resin in the form of an ortho-fused phenolic resole. “Ortho-fused phenolic resole” denotes a phenolic resin whose molecules have (a) aromatic rings formed of phenol monomers and linked in ortho-position through methylene ether bridges, and (b) terminal methylol groups arranged in ortho-position. The term “phenol monomers” here encompasses both unsubstituted phenol and substituted phenols, e.g., cresols. The term “ortho-position” identifies the ortho-position in relation to the hydroxyl group of the phenol. It is not impossible for the molecules of the ortho-fused phenolic resoles for inventive use also to contain aromatic rings linked through methylene groups (in addition to aromatic rings (a) linked through methylene ether bridges) and/or terminal hydrogen atoms in ortho-position (as well as terminal methylol groups in ortho-position (b)). In the molecules of the ortho-fused phenolic resoles for inventive use, the ratio of methylene ether bridges to methylene bridges is at least 1, and the ratio of terminal methylol groups in ortho-position to terminal hydrogen atoms in ortho-position is likewise at least 1. Phenolic resins of these kinds are also referred to as benzyl ether resins. They are obtainable by polycondensation of formaldehyde (optionally in the form of paraformaldehyde) and phenols in a molar ratio of greater than 1:1 to 2:1, preferably 1.23:1 to 1.5:1, catalyzed by divalent metal ions (preferably Zn²⁺) in a weakly acidic medium.

The term “ortho-fused phenolic resole” (alternatively ortho-condensed phenolic resole) encompasses, in accordance with the customary understanding of the skilled person, compounds of the kind disclosed in the textbook “Phenolic Resins: A century of progress” (editor: L. Pilato, publisher: Springer, year of publication: 2010), particularly on page 477 in the form of FIG. 18.22. The term equally encompasses the “Benzyl ether resins (ortho-phenol resoles)” stated in the VDG [German Automakers Association] R 305 datasheet on “Urethane Cold Box Process” (February 1998) in 3.1.1. The term further encompasses the “phenolic resins of the benzyl ether resin type” disclosed in EP 1 057 554 B1-cf. in particular paragraphs [0004] to [0006] there.

The ortho-fused phenolic resole of the phenolic resin component, for inventive use, contains unetherified terminal methylol groups —CH₂OH and/or etherified terminal methylol groups —CH₂OR. In an etherified terminal methylol group, the hydrogen atom which in the unetherified terminal methylol group —CH₂OH is bonded to the oxygen atom is replaced by a radical R. In a first preferred alternative here, R is an alkyl radical—that is, the groups —CH₂OR are alkoxymethylene groups. Preferred in that case are alkyl radicals having 1 to 4 carbon atoms, preferably from the group consisting of methyl, ethyl, propyl, n-butyl, isobutyl, and tert-butyl.

In another preferred alternative, the radical R of the etherified terminal methylol group of the ortho-fused phenolic resole has the structure

—O—Si(OR1)ₘ(OR2)ₙ, where

R1 is selected from the group consisting of hydrogen and ethyl,

R2 is a radical formed from an ortho-fused phenolic resole as described above,

m and n are each integers from the group consisting of 0, 1, 2, and 3, and m+n=3. In this case the ortho-fused phenolic resole of the phenolic resin component is a modified resole comprising units formed from ortho-fused phenolic resole as described above, which are substituted and/or linked by esters of orthosilicic acid. Resins of this kind are preparable by reaction of unetherified hydroxyl groups (i.e., hydroxyl groups of the unetherified terminal methylol groups) of an ortho-fused phenolic resole with one or more esters of orthosilicic acid. Modified resoles of this kind and their preparation are described in references including patent application WO 2009/130335.

In the ortho-fused phenolic resole of the phenolic resin component of the two-component binder of the invention, the ratio of unetherified methylol groups to etherified terminal methylol groups is preferably greater than 1, more preferably greater than 2, with further preference greater than 4, and very preferably greater than 10. In the ortho-fused phenolic resole of the phenolic resin component there are preferably no etherified terminal methylol groups.

Conventionally employed in two-component binder systems for use in the polyurethane cold box process are, preferably, phenolic resins having etherified terminal methylol groups in the form of alkoxymethylene groups —CH₂—OR, in particular with R=ethoxy or methoxy as described in U.S. Pat. No. 4,546,124, since they give foundry cores and foundry molds particularly high strength. Phenolic resins having etherified methylol groups are therefore also used preferably in practice because they exhibit a greater solubility in apolar solvents such as aromatic hydrocarbons, for example. Surprisingly it has been found, however, that the objectives of the present invention are achieved more effectively by using an ortho-fused phenolic resole which contains primarily or even exclusively unetherified terminal methylol groups (as defined above).

The phenolic resin component component of the two-component binder of the invention preferably comprises an ortho-fused phenolic resole having unetherified terminal methylol groups and also a solvent and optionally one or more additives.

The fraction of the ortho-fused phenolic resole in the phenolic resin component is preferably in the range from 30% to 50%, more preferably in the range from 40% to 45%, based on the total mass of the phenolic resin component.

The phenolic resin component of the two-component binder system of the invention comprises a solvent, in which the above-described ortho-fused phenolic resol is in solution. In accordance with the invention, the solvent for the phenolic resin component comprises
no compounds from the group of alkyl silicates and alkyl silicate oligomers

and
compounds from the group of the aromatic hydrocarbons only in an amount such that, based on the total mass of the phenolic resin component, the fraction of aromatic hydrocarbons is less than 39.43%, preferably less than 38%,

and
rapeseed oil methyl ester only in an amount such that, based on the total mass of the phenolic resin component, the fraction of aromatic hydrocarbons is less than 39.43%, preferably less than 30%.

In accordance with the invention, the solvent of the phenolic resin component preferably comprises one or more compounds selected from the group consisting of
dialkyl esters of C₃-C₆ dicarboxylic acids,
saturated and unsaturated fatty acid alkyl esters, preferably vegetable oil alkyl esters, preferably from the group consisting of rapeseed oil methyl ester, tall oil methyl ester, tall oil butyl ester (CAS No. 67762-63-4), lauric acid methyl ester, lauric acid isopropyl ester (isopropyl laurate, CAS No.: 10233-13-3), myristic acid isopropyl ester (isopropyl myristate, CAS No.: 110-27-0), and myristic acid isobutyl ester (isobutyl mystirate (CAS No.: 25263-97-2),
alkylene carbonates, preferably propylene carbonate,
cycloalkanes,
cyclic formals,
aromatic hydrocarbons from the group consisting of alkyl benzenes, alkenyl benzenes, dialkyl naphthalines, and dialkenyl naphthalines,
substances from the group consisting of cashew nut shell oil, components of cashew nut shell oil, and derivatives of cashew nut shell oil, preferably cardol, cardanol, and also derivatives and oligomers of these compounds.

The dialkyl esters of C₃-C₆ dicarboxylic acids are preferably dimethyl esters of C₃-C₆ dicarboxylic acids, more preferably from the group consisting of dimethyl adipate, dimethyl glutarate, dimethyl succinate, and dimethyl malonate.

In the group of the aromatic hydrocarbons, those from the group consisting of dialkyl naphthalines and diakenyl naphthalines, are however not preferred, owing to the toxicity of such compounds.

Among the fatty acid alkyl esters, vegetable oil alkyl esters are preferred on account of their being obtained from renewable raw materials. Preferred vegetable oil alkyl esters are rapeseed oil methyl ester, tall oil methyl ester, tall oil butyl ester, lauric acid methyl ester, lauric acid isopropyl ester, myristic acid isopropyl ester, and myristic acid isobutyl ester. Particularly preferred presently is rapeseed oil methyl ester.

With further preference in accordance with the invention, the solvent of the phenolic resin component comprises or consists of
one or more compounds from the group of the dialkyl esters of C₃-C₆ dicarboxylic acids,

and
one or more compounds in the group of the alkyl benzenes and alkenyl benzenes

and
one or more compounds from the group of the saturated and of the unsaturated fatty acid alkyl esters, preferably from the group of vegetable oil alkyl esters.

With particular preference the solvent of the phenolic resin component comprises or consists of
two or more compounds from the group of the dialkyl esters of C₃-C₆ dicarboxylic acids,

and
two or more compounds from the group of the alkyl benzenes and alkenyl benzenes

and
one or more vegetable oil alkyl esters from the group consisting of rapeseed oil methyl ester, tall oil methyl ester, tall oil butyl ester, lauric acid methyl ester, lauric acid isopropyl ester, myristic acid isopropyl ester, and myristic acid isobutyl ester.

With preference, in the phenolic resin component of the two-component binder system of the invention,
the total mass of compounds from the group of the aromatic hydrocarbons is 5% to 35%, preferably 10% to 30%, more preferably 15% to 25%,

and/or
the total mass of compounds from the group of dialkyl esters of C₃-C₆ dicarboxylic acids is 5% to 35%, preferably 10% to 30%, more preferably 15% to 25%,

and/or
the total mass of fatty acid alkyl esters is 1% to 30%, preferably 5% to 25%, and more preferably 10% to 20%,

based in each case on the total mass of the phenolic resin component.

With preference, in the phenolic resin component of the two-component binder system of the invention,
the total mass of compounds from the group of the aromatic hydrocarbons is 5% to 35%, preferably 10% to 30%, more preferably 15% to 25%,

and
the total mass of compounds from the group of dialkyl esters of C₃-C₆ dicarboxylic acids is 5% to 35%, preferably 10% to 30%, more preferably 15% to 25%, based in each case on the total mass of the phenolic resin component,

and
the total mass of fatty acid alkyl esters is 1% to 30%, preferably 5% to 25%, and more preferably 10% to 20%,

based in each case on the total mass of the phenolic resin component.

With preference, the phenolic resin component of the two-component binder of the invention has a viscosity at 20° C. of at most 100 mPas, preferably of at most 50 mPas, determined in each case according to DIN 53019-1: 2008-09.

With preference, the phenolic resin component of the two-component binder of the invention comprises less than 5%, preferably less than 1%, of monomers selected from the group consisting of monomeric unsubstituted phenol and monomeric substituted phenols, based on the total mass of the phenolic resin component.

A low level of monomeric unsubstituted phenol and monomeric substituted phenols in the phenolic resin component of the two-component binder of the invention is desirable in order
to diminish the emissions of monomeric unsubstituted phenol and monomeric substituted phenols during processing of the two-component binder of the invention, i.e., during production of an article from the group consisting of feeders, foundry molds, and foundry cores by the polyurethane cold-box process
to diminish the emissions of monomeric unsubstituted phenol and monomeric substituted phenols, and also benzene, during casting
to minimize the level of monomeric unsubstituted phenol and monomeric substituted phenols in the waste sand from used feeders, foundry molds, and foundry cores (as characterized by the phenol index), in order reliably to meet safety requirements and environmental protection requirements associated with the landfilling of the waste sand and/or to diminish costs for compliance with safety requirements and environmental protection requirements associated with the landfilling.

The amount of monomeric unsubstituted phenol and monomeric substituted phenols in the phenolic resin components of conventional two-component binders for use in the cold box process is typically situated in the order of magnitude of 4% to 10%, based on the total mass of the phenolic resin component, and the amount of ortho-fused phenolic resol in the phenolic resin component is customarily 50% to 60%, preferably 52% to 55%, based on the total mass of the phenolic resin component.

Reducing further the amount of monomeric unsubstituted phenol and monomeric substituted phenols, by distillation, for example, is difficult, because ortho-fused resoles are sensitive to heat. Under the influence of heat, on the one hand, terminal methylol groups in the molecules of ortho-condensed resoles may enter into condensation reactions with one another, and on the other hand the methylene ether bridges may rupture, with the consequent elimination of formaldehyde. Both processes lead to a change in the structure of the phenolic resin. This is often accompanied by observations of an unwanted increase in the molecular weight. A falling number of methylene ether bridges and a rising number of methylene bridges is generally accompanied by a loss of reactivity. By rapid distillation in a very low vacuum (less than 1 kPa (10 mbar), preferably less than 0.5 kPa (5 mbar)) and at temperatures as low as possible (less than 126° C., preferably less than 110° C.), it is possible to prepare ortho-fused resols having amounts of monomers from the group consisting of monomeric unsubstituted phenol and monomeric substituted phenols of below 2%, based on the mass of the resole, with these resoles meeting the requirement of the cold box process in terms of molecular weight and reactivity. This is surprising, since the removal of monomeric unsubstituted phenol and monomeric substituted phenols, which also function as solvents, raises the viscosity, which could be an additional hindrance to distillation.

The polyisocyanate having at least two isocyanate groups per molecule that is present in the polyisocyanate component of the two-component binder system of the invention is preferably selected from the group consisting of diphenylmethane diisocyanate (methylenebis(phenyl isocyanate), MDI), polymethylene-polyphenyl isocyanates (polymeric MDI), and mixtures thereof. Polymeric MDI optionally comprises molecules having more than two isocyanate groups per molecule.

As polyisocyanate for the polyisocyanate component it is also possible to use isocyanate compounds having at least two isocyanate groups per molecule, which additionally contain at least one carbodiimide group per molecule. Such isocyanate compounds are also termed carbodiimide-modified isocyanate compounds and are described in references including DE 10 2010 051 567 A1.

In one preferred alternative, the polyisocyanate component of the two-component binder system of the invention contains no polyisocyanate in the form of isocyanate compounds having at least two isocyanate groups per molecule which additionally contain per molecule at least one carbodiimide group.

The polyisocyanate component of the two-component binder system of the invention comprises a solvent in which the above-described polyisocyanate having at least two isocyanate groups per molecule is in solution, or comprises no solvent, meaning that the polyisocyanate in the polyisocyanate component is not in solution.

For example the solvent of the polyisocyanate component comprises one or more compounds selected from the group consisting of
alkyl silicates and alkyl silicate oligomers,
dialkyl esters of C₃-C₆ dicarboxylic acids,
saturated and unsaturated fatty acid alkyl esters, preferably vegetable oil alkyl esters, preferably from the group consisting of rapeseed oil methyl ester, tall oil methyl ester, tall oil butyl ester, lauric acid methyl ester, lauric acid isopropyl ester, myristic acid isopropyl ester, and myristic acid isobutyl ester,
alkylene carbonates, preferably propylene carbonate,
cycloalkanes,
cyclic formals,
aromatic hydrocarbons from the group, for example, consisting of alkyl benzenes, alkenyl benzenes, dialkyl naphthalines, and dialkenyl naphthalines.

The dialkyl esters of C₃-C₆ dicarboxylic acids are preferably dimethyl esters of C₃-C₆ dicarboxylic acids, more preferably from the group consisting of dimethyl adipate, dimethyl glutarate, dimethyl succinate, and dimethyl malonate.

In the group of the aromatic hydrocarbons, those from the group consisting of dialkyl naphthalines and diakenyl naphthalines, are not preferred, owing to the toxicity of such compounds.

Among the fatty acid alkyl esters, vegetable oil alkyl esters are preferred because of their being obtained from renewable raw materials. Preferred vegetable oil alkyl esters are rapeseed oil methyl ester, tall oil methyl ester, tall oil butyl ester, lauric acid methyl ester, lauric acid isopropyl ester, myristic acid isopropyl ester, and myristic acid isobutyl ester. Particularly preferred presently is rapeseed oil methyl ester.

The solvent of the polyisocyanate component of the two-component binder of the invention preferably comprises no compounds from the group consisting of alkyl silicates and alkyl silicate oligomers. With particular preference the polyisocyanate component of the two-component binder of the invention comprises no compounds from the group consisting of alkyl silicates and alkyl silicate oligomers.

Preferably the solvent of the polyisocyanate component comprises one or more compounds selected from the group of alkylene carbonates, more preferably propylene carbonate. More preferably the solvent of the polyisocyanate component consists of one or more alkylene carbonates, more particularly propylene carbonate. Very preferably the solvent of the polyisocyanate component consists of propylene carbonate.

The essential purpose of the solvent present in the polyisocyanate component in a small amount (10% or less, preferably 8% or less, more preferably 5% or less, very preferably 2% or less, based in each case on the total mass of the polyisocyanate component) is to protect the polyisocyanate from moisture. The polyisocyanate component of the two-component binder system of the invention preferably contains only an amount of solvent such as is necessary for reliable protection of the polyisocyanate from moisture.

Preferred is a two-component binder system of the invention for use in the polyurethane cold box process, the phenolic resin component and/or the polyisocyanate component comprising as additive one or more substances selected from the group consisting of
silanes such as, for example, aminosilanes, epoxysilanes, mercaptosilanes, and ureidosilanes and chlorosilanes,
acyl chlorides such as, for example, phosphoryl chloride, phthaloyl chloride, and benzene phosphoroxydichloride,
hydrofluoric acid,
methanesulfonic acid
phosphorus-oxygen acids
additive mixture preparable by reacting a premix of
   (av) 1.0 to 50.0 weight percent of methanesulfonic acid,
   (bv) one or more esters of one or more phosphorus-oxygen acids, the total amount of said esters being in the range from 5.0 to 90.0 weight percent,
   and
   (cv) one or more silanes selected from the group consisting of aminosilanes, epoxysilanes, mercaptosilanes and ureidosilanes, the total amount of said silanes being in the range from 5.0 to 90.0 weight percent,
the weight percent figures being based on the total amount of the constituents (av), (bv), and (cv) in the premix.

For the last-mentioned additive it is the case that in one preferred variant the fraction of water is not more than 0.1 weight percent, the weight percent figures being based on the total amount of the constituents (av), (bv), and (cv) in the premix.

The essential purpose of these additives is to extend the time for which the molding mixture mixed with the two binder components can be stored before further processing into foundry molds or foundry cores, in spite of the high reactivity of the binder system (“sand life”). This is achieved by means of additives which inhibit the formation of polyurethane. Long sand lives are needed so that a prepared batch of a molding mixture does not become unusable prematurely. The aforementioned additives are also referred to as bench life extenders and are known to the skilled person. Used typically here, conventionally, in particular are acyl chlorides from the group consisting of phosphoryl chloride POCl₃ (CAS No. 10025-87-3), o-phthaloyl chloride (1,2-benzenedicarbonyl chloride, CAS No. 88-95-9), and benzenephosphoroxydichloride (CAS No.: 842-72-6). Further suitable additives are methanesulfonic acid and phosphorus oxyacids, preferably from the group consisting of phosphinic acid, phosphonic acid, phosphoric acid, peroxophosphoric acid, hypodiphosphonic acid, diphosphonic acid, hypodiphosphoric acid, diphosphoric acid and peroxodiphosphoric acid.

One preferred sand life extender additive is an additive mixture preparable by reacting a premix of the aforementioned components (av), (bv), and (cv) as described in patent application WO 2013/117256.

Inhibitory additives are added customarily except in the case of hydrofluoric acid to the polyisocyanate component of the two-component binder system of the invention. Their concentration is customarily 0.01% to 2% based on the total mass of the polyisocyanate component. Hydrofluoric acid as inhibitory additive is customarily added to the phenolic resin component of the two-component binder system of the invention.

Further functions of the additives optionally present in the phenolic resin component and/or in the polyisocyanate component of the two-component binder system of the invention are to facilitate the removal of cured feeders, foundry cores, and foundry molds from the shaping mold and also to increase the stability on storage, particularly the moisture resistance, of the feeders, foundry cores, and foundry molds produced.

On the basis of his or her art knowledge, the skilled person selects these additives such that they are compatible with all of the constituents of the two-component binder system.

A further aspect of the present invention relates to a mixture for curing by contacting with a tertiary amine. This mixture of the invention
(a) is preparable by mixing the components of the two-component binder system of the invention as defined above,
   and/or
(b) comprises
   an ortho-fused phenolic resole having etherified and/or unetherified terminal methylol groups,
   a polyisocyanate having at least two isocyanate groups per molecule,
   a solvent and also,
   optionally, one or more additives,

the stoichiometric ratio of isocynate groups in the polyisocyanate component to hydroxyl groups in the phenol resin component, in the mixture (both in case (a) and in case (b)), being less than 1.2, and preferably in the range from 0.5 to <1, more preferably in the range from 0.7 to 0.95,

and

the mixture (both in case (a) and in case (b)) being free from compounds in the group of the alkyl silicates and alkyl silicate oligomers

and, based on the total mass of the mixture,
the fraction of aromatic hydrocarbons is less than 27.6%, preferably less than 25%, and
the fraction of rapeseed methyl ester is less than 27.6%, preferably less than 25%.

In the mixture of the invention, the stoichiometric ratio of isocyanate groups in the polyisocyanate component to hydroxyl groups in the phenol resin component is preferably in the range of 0.5 to 1.16, more preferably in the range from 0.55 to 1.1, more preferably still in the range from 0.6 to 0.99, very preferably in the range from 0.7 to 0.95, with particular preference in the range from 0.72 to 0.92, and especially preferably in the range from 0.75 to 0.9.

Based on the total mass of the mixture of the invention (as defined above), preferably
the fraction of aromatic hydrocarbons is 22% or less, more preferably 20% or less, very preferably 15% or less,

and/or
the fraction of rapeseed methyl is ester 22% or less, more preferably 20% or less, very preferably 15% or less.

A mixture of the invention of this kind can be used for binding a mold raw material or a mixture of mold raw materials in the polyurethane cold box process (see below). The mixture of the invention, especially in its preferred embodiments, is notable for the fact that it endows feeders, foundry molds, and foundry cores produced by the polyurethane cold box process with sufficient strength in conjunction with low binder content and addition of a small amount of tertiary amine. The small amounts of binder and of tertiary amine limit the emissions, especially of BTEX aromatics (benzene, toluene, ethylbenzene, xylene), and the odor nuisance. As a result of the smaller ratio, as compared with the prior art, between polyisocyanate in the polyisocyanate component and ortho-fused phenolic resole having etherified and/or unetherified methylol groups in the phenolic resin component, the nitrogen content of the binder is reduced. The effect of this—as well as the low binder content of the feeders, foundry molds, and foundry cores of the invention—is to limit the odor-nuisance emissions by nitrogen-containing compounds and decomposition products thereof during casting and also to reduce the risk of casting defects caused by nitrogen, such as pinhole defects or comma defects, for example.

Variant (a) of the mixture of the invention as described above can be prepared preferably by mixing the components of one of the above-described preferred two-component binder systems of the invention.

For variant (b) of the mixture of the invention as described above, the above observations are applicable with regard to ortho-fused phenolic resoles, polyisocyanates, solvents, additives, and mixing ratios for preferred use.

A further aspect of the present invention relates to a mixture as defined above, further comprising a mold raw material or a mixture of two or more mold raw materials, the ratio of the total mass of mold raw materials to the total mass of other constituents of the mixture being in the range from 100:2 to 100:0.4, preferably from 100:1.5 to 100:0.6. The other constituents of the mixture encompass all constituents of the mixture which are not mold raw materials, more particularly all components of the two-component binder of the invention, i.e., ortho-fused phenolic resole, polyisocyanate, solvent, and, optionally, additives, as defined above. A mixture of the invention of this kind can be used as a molding mixture for producing a foundry mold or a foundry core by the polyurethane cold box process.

A feature of this mixture of the invention, especially in its preferred embodiments, is that foundry molds and foundry cores produced have sufficient strength in conjunction with a low binder content and a low amount of tertiary amine which is necessary for curing. The small amounts of binder and of tertiary amine limit the emissions, especially of BTX aromatics, and the odor nuisance. As a result of the smaller ratio, as compared with the prior art, between polyisocyanate in the polyisocyanate component and ortho-fused phenolic resole having etherified and/or unetherified methylol groups in the phenolic resin component, the nitrogen content of the binder is reduced. The effect of this—as well as the low binder content of the feeders, foundry molds, and foundry cores of the invention—is to limit the odor-nuisance emissions of nitrogen-containing compounds and decomposition products thereof during casting and also to reduce the risk of casting defects caused by nitrogen, such as pinhole defects or comma defects, for example.

Suitable mold raw materials are all mold raw materials customarily used for producing feeders, foundry molds, and foundry cores, examples being silica sand and specialty sands. The term “specialty sand” encompasses natural mineral sands and also sintering and fusion products which are produced in granular form or are converted into granular form by crushing, grinding, and classifying operations, and inorganic mineral sands formed by other physicochemical operations, and used as mold raw materials with conventional foundry binders for the manufacture of feeders, cores, and molds. Specialty sands include the following:
aluminum silicates in the form of natural minerals or mineral mixtures such as J-sand and Kerphalite KF,
aluminum silicates in the form of technical sintered ceramics such as, for example, chamotte and Cerabeads,
natural heavy minerals such as R-sand, chromite sand, and zirconium sand,
technical oxide ceramics such as M-sand and bauxite sand,
and technical non-oxide ceramics such as silicon carbide.

A molding mixture of the invention suitable for producing a feeder by the polyurethane cold box process, i.e., a feeder composition of the invention, comprises

(i) a mixture of the invention which
(a) is preparable by mixing the components of the two-component binder system of the invention as defined above,
or
(b) comprises an ortho-fused phenolic resole having etherified and/or unetherified terminal methylol groups,
   a polyisocyanate having at least two isocyanate groups per molecule,
   a solvent and also,
   optionally, one or more additives,
the stoichiometric ratio of isocyanate groups in the polyisocyanate component to hydroxyl groups in phenolic resin compound in the mixture (both in case (a) and in case (b)), being less than 1.2 and preferably in the range from 0.5 to <1, more preferably in the range from 0.7 to 0.95,
and the mixture (both in case (a) and case (b)) being free from compounds from the group of the alkyl silicates and alkyl silicate oligomers,
and, based on the total mass of the mixture
   the fraction of aromatic hydrocarbons is less than 27.6%, more preferably less than 25%, and
   the fraction of rapeseed oil methyl ester is less than 27.6%, preferably less than 25%.

(ii) customary feeder constituents,

the ratio of the total amount of the customary feeder constituents to the total amount of the mixture of the invention in the feeder composition being in the range from 100:18 to 100:5. The feeder constituents encompass refractory granular fillers, optionally insulating fillers such as hollow microspheres, optionally fiber material, and also, in the case of exothermic feeders, an oxidizable metal and an oxidizing agent for the oxidizable metal. The production of feeders by the polyurethane cold box process and also materials suitable as feeder constituents are known to the skilled person—see, for example, WO 2008/113765 and DE 10 2012 200 967.

In the feeder composition of the invention, the stoichiometric ratio of isocyanate groups in the polyisocyanate component to hydroxyl groups in the phenolic resin component is preferably in the range from 0.5 to 1.16, more preferably in the range from 0.55 to 1.1, with further preference in the range from 0.6 to 0.99, with even further preference in the range from 0.7 to 0.95, very preferably in the range from 0.72 to 0.92, most preferably in the range from 0.75 to 0.9.

A further aspect of the present invention relates to a method for producing a feeder, a foundry mold or a foundry core from a molding mixture, the molding mixture being bound by means of a two-component binder system of the invention as defined above or by means of a mixture of the invention as defined above. As far as preferred features and embodiments of the two-component binder system of the invention and of the mixture of the invention are concerned, the observations above are valid.

The molding mixture for use in the method of the invention comprises a mold raw material or a mixture of two or more mold raw materials and, for the production of a feeder, the aforementioned feeder constituents. In the production of a feeder, a foundry mold or a foundry core from this molding mixture, the mold raw material or the mixture of two or more mold raw materials is bound by means of the two-component binder system of the invention present in the molding mixture, as defined above, or by means of the mixture of the invention present in the molding mixture, as defined above. Suitable mold raw material comprises all mold raw materials customarily used for producing feeders, foundry molds, and foundry cores, as specified above.

The method of the invention comprises the following steps:
providing or producing a mold raw material or a mixture of two or more mold raw materials,
mixing the mold raw material or the mixture of two or more mold raw materials with the phenolic resin component and the polyisocyanate component of a two-component binder system of the invention (as defined above), to form a molding mixture suitable for curing by contacting with a gaseous tertiary amine or with a mixture of two or more gaseous tertiary amines, the stoichiometric ratio of isocyanate groups in the polyisocyanate component to hydroxyl groups in the phenolic resin component in the molding mixture being less than 1.2, and preferably in the range from 0.5 to <1, more preferably in the range from 0.7 to 0.95
shaping the molding mixture,

and
contacting the shaped molding mixture with a tertiary amine or a mixture of two or more gaseous tertiary amines by the polyurethane cold box process, so that the shaped molding mixture cures to form the feeder, the foundry mold or the foundry core.

In the molding mixture formed in the method of the invention, the stoichiometric ratio of isocyanate groups in the polyisocyanate component to hydroxyl groups in the phenolic resin component is preferably in the range from 0.5 to 1.16, more preferably in the range from 0.55 to 1.1, with further preference in the range from 0.6 to 0.99, with even further preference in the range from 0.7 to 0.95, very preferably in the range from 0.72 to 0.92, most preferably in the range from 0.75 to 0.9.

The molding mixture is customarily shaped by being filled, blown or shot into a shaping mold and thereafter—optionally—compacted.

The contacting of the shaped molding mixture with a tertiary amine (the term “tertiary amine” for the purposes of this application also including mixtures of two or more tertiary amines) is accomplished preferably in accordance with the polyurethane cold box process.

The tertiary amine is preferably selected from the group consisting of triethylamine, dimethylethylamine, diethylmethylamine, dimethylisopropylamine, dimethylpropylamine and mixtures thereof. The tertiary amines to be used are liquid at room temperature and for use in the polyurethane cold box process are evaporated by supply of heat, and the evaporated tertiary amine is sprayed or injected into the shaping mold.

Surprisingly it has emerged that, in preferred variants of the method of the invention, an amount of tertiary amine of less than 0.08 mol, preferably less than 0.05 mol, more preferably less than 0.035 mol per mole of isocyanate groups of the polyisocyanate present in the polyisocyanate component of the two-component binder system of the invention is sufficient to cure the shaped molding mixture and so to form the feeder, the foundry mold or the foundry core. Lowering the amounts required of tertiary amine is advantageous not only on account of the lower odor nuisance and the reduced costs due to the reduced employment of material, but also on account of the correspondingly lower expenditure on isolating and recycling the tertiary amines.

Surprisingly it has emerged that this small amount of gaseous tertiary amine per mole of isocyanate groups of the polyisocyanate present in the polyisocyanate component of the two-component binder system of the invention is sufficient to cure the shaped molding mixture and so to form the feeder, the foundry mold or the foundry core.

The method of the invention, especially in its preferred embodiments, is notable for the fact that it permits the production of feeders, foundry molds, and foundry cores having a low binder content and addition of a small amount of tertiary amine without adversely affecting the strength of the feeders, foundry molds, and foundry cores. The small amounts of binder and tertiary amine limit the emissions, particularly of BTEX aromatics, and the odor nuisance. The effect of the smaller ratio of polyisocyanate in the polyisocyanate component to ortho-fused phenolic resole having etherified and/or unetherified methylol groups in the phenolic resin component as compared with the prior art, is to reduce the nitrogen content of the binder. The effect of this—as well as the low binder content of the feeders, foundry molds, and foundry cores of the invention—is to limit the odor-nuisance emissions of nitrogen-containing compounds during casting and also to reduce the risk of nitrogen-induced casting defects, such as pinhole defects or comma defects, for example.

A further aspect of the present invention relates to an article from the group consisting of feeders, foundry molds and foundry cores, producible by the method of the invention as described above. With regard to preferred embodiments of the method of the invention, the observations above are valid. The feeders, foundry molds and/or foundry cores of the invention are notable for high strength with low binder content relative to the overall mass of the feeder, the foundry core or the foundry mold.

A further aspect of the present invention relates to the use of a two-component binder system of the invention as defined above or of a mixture of the invention as defined above for binding a mold raw material or a mixture of mold raw materials in the polyurethane cold box process. As far as preferred features and embodiments of the two-component binder system of the invention and of the mixture of the invention are concerned, the observations above are valid.

The invention is elucidated further below using working examples and comparative examples.

From molding mixtures comprising a customary mixture of mold raw materials and also a two-component binder system comprising a polyisocyanate component and a phenolic resin component as described below, test specimens in the form of flexural bars are produced by the cold box process, and their initial flexural strengths are determined.

The production of the test specimens (+GF+ standard flexural strength test specimens) is carried out in accordance with VDG datasheet P73. For this purpose, the mold raw material is charged to a mixing vessel. The phenolic resin component and polyisocyanate component (ii) (amounts, see table 1) are then weighed into the mixing vessel in such a way that they do not undergo direct mixing. Thereafter, mold raw material, phenolic resin component, and polyisocyanate component are mixed in a paddle mixer (Multiserw, model RN10/P) for 2 minutes at approximately 220 revolutions/minute to form a molding mixture.

The production of test specimens takes place with a universal core shooting machine LUT, which is equipped with a Gasoman LUT/G, both from Multiserw. Immediately after its production as described above, the completed molding mixture is filled into the shooting head of the core shooting machine or initially stored for one hour in the closed container.

The parameters of the core shooting operation are as follows: shoot time: 3 seconds, delay time after shooting: 5 seconds, shooting pressure: 4 bar (400 kPa). For curing, the test specimens are gassed for 10 seconds at a gassing pressure of 2 bar (200 kPa) with dimethylpropylamine (DMPA). This is followed by flushing with air for 9 seconds at a flushing pressure of 4 bar (400 kPa). The flexural strength is measured using a Multiserw LRu-2e instrument at specific times (15 seconds, one hour, 24 hours, see table 2) after the end of flushing.

In the production of the test specimens, the following parameters were varied:
solvent content and solvent composition of the phenolic resin component
solvent content and solvent composition of the polyisocyanate component
additives present
ratio of the mass of polyisocyanate in the polyisocyanate component to the mass of resole in the phenolic resin component
storage time of the molding mixture

The compositions of the two-component binder systems and molding mixtures used are listed in table 1.

The phenolic resin component comprises a resole having unetherified terminal methylol groups, i.e., terminal groups of the structure —CH₂OH, and a solvent comprising the following constituents

LM1 dimethyl esters of C₄-C₆ dicarboxylic acids

LM2 mixture of aromatic hydrocarbons

LM3 rapeseed oil methyl esters

The phenolic resin component of examples 1.1 and 1.2 comprises as additives a silane and 40% strength hydrofluoric acid (sand life extender additive). In the other examples, the phenolic resin component does not comprise any additives.

The polyisocyanate component comprises diphenylmethane diisocyanate (methylenebis(phenyl isocyanate), MDI) as polyisocyanate and also a sand life extender additive and as solvent a mixture of aromatic hydrocarbons.

The polyisocyanate component of examples 1.1, 1.2 and 1.3 comprises as sand life extender additive an additive mixture preparable by reacting a premix of the aforementioned components (av), (bv), and (cv) as described in patent application WO 2013/117256 in an amount of 1.2%, based on the total mass of the polyisocyanate component (example 1.1) or 1.4%, based on the total mass of the polyisocyanate component (examples 1.2 and 1.3). The polyisocyanate component of examples 2.1, 2.2 and 2.3 comprises as sand life extender additive phosphorus oxychloride in an amount of 0.3%, based on the total mass of the polyisocyanate component.

In noninventive examples 1.1 and 2.1, the two components of the binder system were each used in a quantity and composition customary in the prior art, and so these examples serve as a reference. In the inventive examples, the solvent fraction of the polyisocyanate component is reduced compared to the reference example and the solvent fraction of the phenolic resin component is increased compared to the reference example. In all inventive examples, the stoichiometric ratio of isocyanate groups in the polyisocyanate component to hydroxyl groups in the phenolic resin component is less than 1.2, in examples 1.3 and 2.3 even less than 1.

In table 1, the definitions are as follows:

| | |
|---|---|
| PBW | Parts by weight |
| MRM | Mold raw material |
| LM | Solvent |
| BM | Binder (minus solvent and additives). |

The results of the measurements of the flexural strength as a function of the storage time of the molding mixture prior to core production, and as a function of the time elapsed after the end of rinsing, are compiled in table 2. The flexural strength values measured at the time of 15 s after the end of rinsing are critical for the usability of cores and are referred to below as initial strengths.

TABLE 1

| | | | | | | | | | Composition of molding mixture | |
|---|---|---|---|---|---|---|---|---|---|---|
| | | | | | | | | | PBW | |
| | | | | | | | | | phenolic | PBW |
| | | | | | | Composition of | | | resin | polyisoccyanate |
| | Composition of phenolic resin | | | | | Polyisoyante | | | component/ | component/ |
| | component | | | | | component | | | 100 | 100 |
| Example | Resole | LM1 | LM2 | LM3 | Additives | MDI | LM | Additives | PBW | PBW |
| No. | [%] | [%] | [%] | [%] | [%] | [%] | [%] | [%] | MRM | MRM |
| 1.1 | 50.83 | 17.1 | 18.63 | 12.99 | 0.45 | 85 | 13.8 | 1.2 | 0.75 | 0.75 |
| 1.2 | 47 | 20 | 20 | 13 | 0 | 95 | 3.6 | 1.4 | 0.9 | 0.6 |
| 1.3 | 44 | 21 | 21 | 14 | 0 | 95 | 3.6 | 1.4 | 1 | 0.5 |
| 2.1 | 50.83 | 17.1 | 18.63 | 12.99 | 0.45 | 85 | 14.7 | 0.3 | 0.75 | 0.75 |
| 2.2 | 47 | 20 | 20 | 13 | 0 | 95 | 4.3 | 0.7 | 0.9 | 0.6 |
| 2.3 | 44 | 21 | 21 | 14 | 0 | 95 | 4.3 | 0.7 | 1 | 0.5 |

| | Composition of molding mixture | | | | | | |
|---|---|---|---|---|---|---|---|
| | | | | | | Amount | |
| | | | | | | of substance | |
| | PDW | PDW | | PBW | Amount | [mol] | |
| | resole/ | MDI/ | | BM/ | of substance | NCO/ | Amount |
| | 100 | 100 | Mass | 100 | [mol] OH/ | 100 | of substance |
| Example | PDW | PDW | ratio | PBW | 100 PBW | PBW | ratio |
| No. | MRM | MRM | MDI/resole | MRM | MRM | MRM | NCO/OH |
| 1.1 | 0.38 | 0.64 | 1.680 | 1.02 | 0.00359 | 0.00483 | 1.3451 |
| 1.2 | 0.40 | 0.57 | 1.439 | 0.97 | 0.00374 | 0.00431 | 1.1528 |
| 1.3 | 0.44 | 0.48 | 1.080 | 0.88 | 0.00416 | 0.00360 | 0.8646 |
| 2.1 | 0.38 | 0.64 | 1.680 | 1.02 | 0.00359 | 0.00483 | 1.3451 |
| 2.2 | 0.40 | 0.57 | 1.439 | 0.97 | 0.00374 | 0.00431 | 1.1528 |
| 2.3 | 0.44 | 0.48 | 1.080 | 0.88 | 0.00416 | 0.00360 | 0.8646 |

TABLE 2

| | Molding mixture | | | Molding mixture | | |
|---|---|---|---|---|---|---|
| | used immediately | | | used after one-hour storage | | |
| | Flexural strength [N/cm²] after | | | | | |
| Example | 15 s | 1 h | 24 h | 15 s | 1 h | 24 h |
| No. | after end of rinsing | | | | | |
| 1.1 | 217 | 380 | 480 | 200 | 395 | 470 |
| 1.2 | 230 | 370 | 435 | 235 | 365 | 435 |
| 1.3 | 245 | 330 | 425 | 250 | 370 | 425 |
| 2.1 | 220 | 390 | 480 | 205 | 385 | 465 |
| 2.2 | 240 | 395 | 455 | 255 | 410 | 460 |
| 2.3 | 250 | 355 | 430 | 270 | 375 | 435 |

In the examples with a binder system of the invention (1.2, 1.3, 2.2, 2.3) higher initial flexural strengths are obtained, despite the fact that the binder content (without solvents and additives) of the molding mixture here is lower than in the reference examples. The fact that the flexural strengths are lower, after one hour and/or after 24 h, in the case of the examples of the invention, relative to certain reference examples, is of minor significance in practice. The critical factor, in the case of partly and fully automated core fabrication operations, instead, is that the initial strengths are high, in order to prevent rupturing of the cores during handling.

Surprisingly, the molding mixtures of the invention exhibit greater shelf life than in the reference examples, irrespective of the additive used. It is evident from the fact that the flexural strengths of test specimens produced from a molding mixture of the invention stored for one hour in a closed container do not drop relative to the corresponding flexural strengths of the cores produced from the freshly mixed molding mixture of the invention.

1. A two-component binder system for use in the polyurethane cold box process consisting of a phenolic resin component and of a separate polyisocyanate component, where
the phenolic resin component comprises an ortho-fused phenolic resole having etherified and/or unetherified terminal methylol groups, and a solvent, and optionally one or more additives
and
the polyisocyanate component comprises a polyisocyanate having at least two isocyanate groups per molecule and also optionally a solvent, and optionally one or more additives,
the fraction of isocyanate groups in the polyisocyanate component being 90% or more, preferably 92% or more, more preferably 95% or more, very preferably 98% or more, based in each case on the total mass of the polyisocyanate component,
and
the stoichiometric ratio of isocyanate groups in the polyisocyanate component to hydroxyl groups in the phenolic resin component being less than 1.2, and preferably in the range from 0.5 to <1, more preferably in the range from 0.7 to 0.95,
where
the phenolic resin component is free from compounds from the group of the alkyl silicates and alkyl silicate oligomers,
and, based on the total mass of the phenolic resin component,
the fraction of aromatic hydrocarbons is less than 39.43%, preferably less than 38%,
and the fraction of rapeseed oil methyl ester is less than 39.43%, preferably less than 30%.

2. The two-component binder system as claimed in claim 1,
the ratio of unetherified terminal methylol groups to etherified terminal methylol groups in the ortho-fused phenolic resole being greater than 1, preferably greater than 2, more preferably greater than 4, and very preferably greater than 10, there preferably being no etherified methylol groups in the ortho-fused phenolic resole,
and/or
the polyisocyanate having at least two isocyanate groups per molecule being selected from the group consisting of diphenylmethane diisocyanate, polymethylene-polyphenyl isocyanates (polymeric MDI), and mixtures thereof.

3. The two-component binder system as claimed in claim 1, the solvent of the phenolic resin component comprising one or more compounds selected from the group consisting of
dialkyl esters of C₃-C₆ dicarboxylic acids,
saturated and unsaturated fatty acid alkyl esters, preferably vegetable oil alkyl esters, preferably from the group consisting of rapeseed oil methyl ester, tall oil methyl ester, tall oil butyl ester, lauric acid methyl ester, lauric acid isopropyl ester, myristic acid isopropyl ester, and myristic acid isobutyl ester,
alkylene carbonates, preferably propylene carbonate,
cycloalkanes,
cyclic formals,
aromatic hydrocarbons from the group consisting of alkyl benzenes, alkenyl benzenes, dialkyl naphthalines, and dialkenyl naphthalines,
substances from the group consisting of cashew nut shell oil, components of cashew nut shell oil, and derivatives of cashew nut shell oil, preferably cardol, cardanol, and also derivatives and oligomers of these compounds.

4. The two-component binder system as claimed in claim 1, the solvent of the phenolic resin comprising:
one or more compounds from the group of dialkyesters of C₃-C₆ dicarboxylic acids,
one or more compounds from the group of the alkyl benzenes and alkenylbenzenes,
and one or more compounds from the group of the saturated and of the unsaturated fatty acid alkyl esters, preferably vegetable oil alkyl esters, preferably from the group consisting of rapeseed oil methyl ester, tall oil methyl ester, tall oil butyl ester, lauric acid methyl ester, lauric acid isopropyl ester, myristic acid isopropyl ester, and myristic acid isobutyl ester.

5. The two-component binder system as claimed in claim 1, the phenolic resin component
having a viscosity at 20° C. of at most 100 mPas, preferably of at most 50 mPas, determined in each case according to DIN 53019-1: 2008-09
and/or
comprising less than 5%, preferably less than 1%, of monomers selected from the group consisting of monomeric unsubstituted phenol and monomeric substituted phenols, based on the total mass of the phenolic resin component.

6. The two-component binder system as claimed in claim 1, the solvent of the polyisocyanate component comprising one or more compounds selected from the group consisting of
dialkyl esters of C₃-C₆ dicarboxylic acids,
saturated and unsaturated fatty acid alkyl esters, preferably vegetable oil alkyl esters, preferably from the group consisting of rapeseed oil methyl ester, tall oil methyl ester, tall oil butyl ester, lauric acid methyl ester, lauric acid isopropyl ester, myristic acid isopropyl ester, and myristic acid isobutyl ester,
alkylene carbonates, preferably propylene carbonate,
cycloalkanes,
cyclic formals,
aromatic hydrocarbons from the group consisting of alkyl benzenes, alkenyl benzenes, dialkyl naphthalines, and dialkenyl naphthalines.

7. The two-component binder system as claimed in claim 1, the phenolic resin component and/or the polyisocyanate component comprising as additive one or more substances selected from the group consisting of
silanes,
acyl chlorides,
hydrofluoric acid,
methanesulfonic acid
phosphorus-oxygen acids
additive mixture preparable by reacting a premix of
(av) 1.0 to 50.0 wt % of methanesulfonic acid,
(bv) one or more esters of one or more phosphorus-oxygen acids, the total amount of said esters being in the range from 5.0 to 90.0 wt %,
and
(cv) one or more silanes selected from the group consisting of aminosilanes, epoxysilanes, mercaptosilanes and ureidosilanes, the total amount of said silanes being in the range from 5.0 to 90.0 wt %,
the fraction of water being no more than 0.1 wt %,
based in each case on the total amount of constituents (av), (bv), and (cv) in the premix.

8. A mixture for curing by contacting with a tertiary amine or with a mixture of two or more tertiary amines, the mixture
(a) being preparable by mixing the components of the two-component binder system as claimed in claim 1,
and/or
(b) comprising an ortho-fused phenolic resole having etherified and/or unetherified terminal methylol groups,
a polyisocyanate having at least two isocyanate groups per molecule,
a solvent and also,
optionally, one or more additives,
and the stoichiometric ratio of isocyanate groups in the polyisocyanate component to hydroxyl groups in the phenolic resin component being less than 1.2, and being preferably in the range from 0.5 to <1, more preferably in the range from 0.7 to 0.95,
the mixture being free from compounds from the group of the alkyl silicates and alkyl silicate oligomers,
and, based on the total mass of the mixture,
the fraction of aromatic hydrocarbons is less than 27.6%, preferably less than 25%, and
the fraction of rape seed methyl ester is less than 27.6%, preferably less than 25%.

9. The mixture as claimed in claim 8, further comprising a mold raw material or a mixture of two or more mold raw materials, the ratio of the total mass of mold raw materials to the total mass of other constituents of the mixture being in the range from 100:2 to 100:0.4, preferably from 100:1.5 to 100:0.6.

10. A method for producing an article from the group consisting of feeders, foundry molds and foundry cores, comprising the following steps:
providing or producing a mold raw material or a mixture of two or more mold raw materials,
mixing the mold raw material or the mixture of two or more mold raw materials with the phenolic resin component and the polyisocyanate component of a two-component binder system as claimed in claim 1, to form a molding mixture suitable for curing by contacting with a gaseous tertiary amine or with a mixture of two or more gaseous tertiary amines, the stoichiometric ratio of isocyanate groups in the polyisocyanate component to hydroxyl groups in the phenolic resin component in the molding mixture being less than 1.2, and preferably in the range from 0.5 to <1, more preferably in the range from 0.7 to 0.95
shaping the molding mixture,
and contacting the shaped molding mixture with a gaseous tertiary amine or a mixture of two or more gaseous tertiary amines by the polyurethane cold box process, so that the shaped molding mixture cures to form the article from the group consisting of feeders, foundry molds and foundry cores, a total amount of gaseous tertiary amines being used which is less than 0.08 mol, preferably less than 0.05 mol, per mole of isocyanate groups.

11. An article from the group consisting of feeders, foundry molds and foundry cores, producible by a method as claimed in claim 10.

12. (canceled)

13. A method for binding a mold raw material or a mixture of mold raw materials in the polyurethane cold box process, comprising:
utilizing a two-component binder system as claimed in claim 1 as a binding for a mold raw material or a mixture of mold raw materials in the polyurethane cold box process.
